(19) United States
(12) Patent Application Publication
(10) Pub. No.: US 2023/0365459 A1
(43) Pub. Date: Nov. 16, 2023

(54) COATED GLAZING

(71) Applicant: Pilkington Group Limited, Lathom (GB)

(72) Inventors: David RIMMER, St. Helens, Merseyside (GB); Jack BROWN, Aigburth, Liverpool, Merseyside (GB); John William OLDFIELD, St. Helens, Merseyside (GB); Christian EIBL, Duisburg (DE); Peter Michael HARRIS, Chester, Cheshire (GB); Tobias BREIL, Dorsten (DE)

(73) Assignee: Pilkington Group Limited, Lathom (GB)

(21) Appl. No.: 18/250,233

(22) PCT Filed: Oct. 26, 2021
(86) PCT No.: PCT/GB2021/052784

§ 371 Date: Apr. 24, 2023

(30) Foreign Application Priority Data
Oct. 26, 2020 (GB) 2016970.2

(51) Int. Cl. C03C 17/34; C03C 23/00

(52) U.S. Cl. CPC C03C 17/3417; C03C 23/002; C03C 2217/212; C03C 2217/211; C03C 2217/228; C03C 2217/71; C03C 2217/76; C03C 2217/90

(57) ABSTRACT

A coated glazing includes a transparent glass substrate and a coating located on the glass substrate. The coating includes at least the following layers in sequence starting from the glass substrate: a first layer having a refractive index of more than 1.6, an optional second layer having a refractive index that is less than the refractive index of the first layer, a third layer based on tin dioxide doped with fluorine, and a fourth layer based on titanium oxide, wherein the fourth layer is photocatalytic.

The present invention relates to a coated glazing for reducing or preventing the formation of condensation which may otherwise occur on the outermost surface of a glazing, and to the use of such a glazing. Said glazing can also provide low emissivity, self-cleaning and antimicrobial properties.

The problem of the formation of condensation (dew) on the outermost surface of glazings is well known. Condensation can form on such a surface when the temperature of that surface drops to a temperature below the dew point, which is the humidity-dependent temperature at which water vapour in air condenses to form water droplets.

Condensation is a problem because visibility through the glazing is reduced, often to the extent that nothing can be seen through the glazing when a person tries to look into or out from the structure in which it is installed. The view through such a glazing may effectively become undesirably obstructed. This observation holds for all kinds of glazings including monolithic (i.e. single panes of glass), laminated glazings (i.e. having two or more panes of glass joined together by a ply of interlayer material extending between them) and multiple pane glazing units (i.e. having two or more panes of glass separated by a gaseous layer or a vacuum in a sealed space between each pane). The problem of condensation is particularly common in the case of skylights (windows set in, and generally at the same angle as, a roof or ceiling).

Another property of interest is photocatalytic activity which arises by the photogeneration, in a semiconductor, of a hole-electron pair when the semiconductor is illuminated by ultraviolet light. The hole-electron pair can be generated in sunlight and can react in humid air to form hydroxy and peroxy radicals on the surface of the semiconductor. The radicals oxidise organic grime on the surface, causing its structural degradation. These organic contaminants are subsequently washed away by water. This property has an application in self-cleaning substrates, especially in self-cleaning glass for windows. This is also an especially important consideration for a coating layer designed such that the formation of condensation on it is reduced or eliminated, because the presence of dirt or other organic contaminants typically leads to nucleation of water droplets (because of the change in contact angle on the surface that the water contacts), thus encouraging formation of condensation. The cleaner the exposed surface of the coating, the less likely it is that condensation will form, and the better the synergy with the low emissivity and hydrophilic properties of the glazing.

WO 2009106864 A1 describes the provision of a photoactive, hydrophilic, low emissivity coating layer on the outermost surface of a pane of glass. However, it would be useful to further improve the properties of the hitherto known products.

Additionally, it would be desirable to provide a glazing with the aforementioned properties that also affords antimicrobial characteristics. There is a need to prevent the transmission of potentially harmful microbes between humans and animals. In the context of the present invention, microbes include bacteria, viruses and fungi. One way in which microbes are transmitted is by “surface transmission”. This is where an individual interacts with a surface that has previously been seeded with microbes, for example by previous interaction with the surface by infectious individuals.

Glazings are commonly found in environments that are shared by multiple individuals and therefore may act as vectors for the transmission of microbes especially bacteria and viruses. This is particularly a problem in spaces which may be occupied by large numbers of people in succession, such as toilets, corridors, hospital rooms, shops and workplaces. Thus it would be useful to provide a glazing that reduces the prevalence of microbes on its surface.

According to a first aspect of the present invention there is provided a coated glazing comprising:
a transparent glass substrate, and
a coating located on the glass substrate,
wherein the coating comprises at least the following layers in sequence starting from the glass substrate:
a first layer having a refractive index of more than 1.6,
an optional second layer having a refractive index that is less than the refractive index of the first layer,
a third layer based on tin dioxide doped with fluorine, and
a fourth layer based on titanium oxide, wherein the fourth layer is photocatalytic.

Surprisingly it has been found that the coated glazing of the first aspect provides improved performance in terms of reducing or preventing the formation of condensation on the glazing. Said glazing can also provide low emissivity, self-cleaning and antimicrobial properties.

In the context of the present invention, where a layer is said to be “based on” a particular material or materials, this means that the layer predominantly consists of the corresponding said material or materials, which means typically that it comprises at least about 50 at. % of said material or materials.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

References herein such as “in the range x to y” are meant to include the interpretation “from x to y” and so include the values x and y.

In the context of the present invention a transparent material or a transparent substrate is a material or a substrate that is capable of transmitting visible light so that objects or images situated beyond or behind said material can be distinctly seen through said material or substrate.

In the context of the present invention the “thickness” of a layer (or coating) is, for any given location at a surface of the layer, represented by the distance through the layer, in the direction of the smallest dimension of the layer, from said location at a surface of the layer to a location at an opposing surface of said layer.

It should be noted that the refractive index values described herein are reported as average values across 400-780 nm of the electromagnetic spectrum.

In the context of the present invention the “film side” of the transparent glass substrate means a major surface of the glass substrate upon which the coating is located. In the context of the present invention the “glass side” of the transparent glass substrate means a major surface of the glass substrate opposing the major surface upon which the coating is located.

Preferably the glazing further comprises an intervening layer based on an oxide of silicon and located between the third and fourth layers. The presence of this layer is advantageous since it affords improvements in self-cleaning and antimicrobial performance. Preferably the intervening layer is based on silicon dioxide, although other stoichiometries may be used.

Preferably the glazing further comprises a lower layer having a refractive index that is less than the refractive index of the first layer and wherein the lower layer is located between the glass substrate and the first layer. Preferably the lower layer is based on an oxide of a metalloid, more preferably based on an oxide of silicon or silicon oxynitride. More preferably the lower layer is based on an oxide of silicon, most preferably based on silicon dioxide, although other stoichiometries may be used. The presence of the lower layer is beneficial since it can reduce the overall haze of the glazing, making the aesthetics more acceptable.

Preferably the lower layer is in direct contact with the glass substrate. Preferably the lower layer is in direct contact with the first layer. In an alternative embodiment the first layer may be in direct contact with the glass substrate. Preferably the first layer is in direct contact with the second layer. Preferably the second layer is in direct contact with the third layer. Preferably the third layer is in direct contact with the intervening layer. Preferably the intervening layer is in direct contact with the fourth layer. Preferably the coating consists of the lower layer, the first layer, the second layer, the third layer, the intervening layer and the fourth layer.

Preferably the lower layer has a thickness of at least 5 nm, more preferably at least 9 nm, even more preferably at least 12 nm, most preferably at least 14 nm, but preferably at most 30 nm, more preferably at most 22 nm, even more preferably at most 18 nm, most preferably at most 16 nm.

When the intervening layer is not present, preferably the first layer has a thickness of at least 5 nm, more preferably at least 10 nm, even more preferably at least 14 nm, most preferably at least 18 nm, but preferably at most 40 nm, more preferably at most nm, even more preferably at most 25 nm, most preferably at most 23 nm.

When the intervening layer is present, preferably the first layer has a thickness of at least 5 nm, more preferably at least 10 nm, even more preferably at least 12 nm, most preferably at least 13 nm, but preferably at most 35 nm, more preferably at most 25 nm, even more preferably at most 20 nm, most preferably at most 15 nm.

When the intervening layer is not present, preferably the second layer has a thickness of at least 5 nm, more preferably at least 12 nm, even more preferably at least 15 nm, most preferably at least 18 nm, but preferably at most 40 nm, more preferably at most nm, even more preferably at most 25 nm, most preferably at most 22 nm.

When the intervening layer is present, preferably the second layer has a thickness of at least 15 nm, more preferably at least 20 nm, even more preferably at least 25 nm, most preferably at least 28 nm, but preferably at most 50 nm, more preferably at most 40 nm, even more preferably at most 35 nm, most preferably at most 30 nm.

When the intervening layer is not present, preferably the third layer has a thickness of at least 130 nm, more preferably at least 160 nm, even more preferably at least 175 nm, most preferably at least 185 nm, but preferably at most 365 nm, more preferably at most 315 nm, even more preferably at most 265 nm, most preferably at most 215 nm.

When the intervening layer is present, preferably the third layer has a thickness of at least 100 nm, more preferably at least 120 nm, even more preferably at least 130 nm, most preferably at least 135 nm, but preferably at most 300 nm, more preferably at most 200 nm, even more preferably at most 160 nm, most preferably at most 150 nm.

Preferably the intervening layer has a thickness of at least 5 nm, more preferably at least 12 nm, even more preferably at least 15 nm, most preferably at least 18 nm, but preferably at most 40 nm, more preferably at most 30 nm, even more preferably at most nm, most preferably at most 22 nm.

When the intervening layer is not present, preferably the fourth layer has a thickness of at least 8 nm, more preferably at least 13 nm, even more preferably at least 15 nm, most preferably at least 16 nm, but preferably at most 40 nm, more preferably at most nm, even more preferably at most 23 nm, most preferably at most 18 nm.

When the intervening layer is present, preferably the fourth layer has a thickness of at least 5 nm, more preferably at least 10 nm, even more preferably at least 13 nm, most preferably at least 14 nm, but preferably at most 35 nm, more preferably at most 25 nm, even more preferably at most 18 nm, most preferably at most 16 nm.

Preferably the first layer has a refractive index of 1.8 or more. More preferably the first layer has a refractive index of from 1.8 to 2.5. Even more preferably the first layer has a refractive index of from 1.8 to 2.2.

Preferably the first layer is based on an oxide of a metal, more preferably the first layer is based on tin dioxide, niobium oxide, titanium dioxide, SiCO or tantalum oxide. Preferably, when the first layer is based on tin dioxide, niobium oxide, titanium dioxide or tantalum oxide, the second layer is present. Preferably, when the first layer is based on SiCO, the second layer is not present. Most preferably the first layer is based on tin dioxide. In certain embodiments, the first layer may consist essentially of tin dioxide. Preferably the first layer consists of tin dioxide. Preferably the first layer is undoped.

Preferably the second layer has a refractive index of 1.6 or less. More preferably the second layer has a refractive index of from 1.2 to 1.6. Even more preferably the second layer has a refractive index of from 1.2 to 1.5.

Preferably the second layer is present. Preferably the second layer is based on an oxide of a metalloid, more preferably the second layer is based on silicon dioxide or silicon oxynitride. Most preferably the second layer is based on silicon dioxide. In certain embodiments, the second layer may consist essentially of silicon dioxide. Preferably the second layer consists of silicon dioxide. Preferably the second layer is undoped. Preferably the second layer is present.

Preferably for the third layer based on tin dioxide doped with fluorine, the dopant is present in an amount of at least 1.0 at %, more preferably at least 1.5 at %, even more preferably at least 2.0 at %, most preferably at least 2.5 at %, but preferably at most 10.0 at %, more preferably at most 5.0 at %, even more preferably at most 3.5 at %, most preferably at most 3.0 at %.

Preferably the fourth layer is based on titanium dioxide, more preferably titanium dioxide with a predominantly anatase crystal structure. More preferably, the fourth layer comprises titanium dioxide with greater than or equal to 50% anatase. It has been found that the coated glazing has excellent antimicrobial properties, especially when illuminated with UV light. Furthermore, it has been found that, following irradiation of the coated glazing with UV light, an increased antimicrobial effect persists even in the absence of any light at all.

Any of the layers of the coating may also comprise other constituents including a trace amount or more of other elements such as, for example, carbon. As used herein, the phrase “trace amount” is an amount of a constituent of a coating layer that is not always quantitatively determinable because of its minuteness.

Preferably the coated glazing comprises:
a transparent glass substrate, and
a coating located on the glass substrate,
wherein the coating comprises at least the following layers in sequence starting from the glass substrate:
a first layer having a refractive index of more than 1.6,
a second layer having a refractive index that is less than the refractive index of the first layer,
a third layer based on tin dioxide doped with fluorine,
an intervening layer based on an oxide of silicon, and
a fourth layer based on titanium dioxide, wherein the fourth layer is photocatalytic.

More preferably the coated glazing comprises:
a transparent glass substrate, and
a coating located on the glass substrate,
wherein the coating comprises at least the following layers in sequence starting from the glass substrate:
a first layer having a refractive index of more than 1.6, wherein the first layer is based on tin dioxide,
a second layer having a refractive index that is less than the refractive index of the first layer, wherein the second layer is based on an oxide of silicon,
a third layer based on tin dioxide doped with fluorine,
an intervening layer based on an oxide of silicon, and
a fourth layer based on titanium dioxide, wherein the fourth layer is photocatalytic.

More preferably the coated glazing comprises:
a transparent glass substrate, and
a coating located on the glass substrate,
wherein the coating comprises at least the following layers in sequence starting from the glass substrate:
a first layer having a refractive index of more than 1.6, wherein the first layer is based on tin dioxide, wherein the first layer has a thickness of at least 5 nm, but at most 35 nm;
a second layer having a refractive index that is less than the refractive index of the first layer, wherein the second layer is based on silicon dioxide, wherein the second layer has a thickness of at least 15 nm, but at most 50 nm;
a third layer based on tin dioxide doped with fluorine, wherein the third layer has a thickness of at least 100 nm, but at most 300 nm;
an intervening layer based on silicon dioxide, wherein the intervening layer has a thickness of at least 5 nm, but at most 40 nm; and
a fourth layer based on titanium dioxide, wherein the fourth layer is photocatalytic and wherein the fourth layer has a thickness of at least 5 nm, but at most 35 nm.

For the immediately preceding three paragraphs, in some embodiments it is preferred that the coating consists of the first layer, the second layer, the third layer, the intervening layer and the fourth layer.

Generally it is preferred that the coated glazing comprises:
a transparent glass substrate, and
a coating located on the glass substrate,
wherein the coating comprises at least the following layers in sequence starting from the glass substrate:
a lower layer based on an oxide of silicon,
a first layer having a refractive index of more than 1.6, wherein the first layer is based on tin dioxide,
a second layer having a refractive index that is less than the refractive index of the first layer, wherein the second layer is based on an oxide of silicon,
a third layer based on tin dioxide doped with fluorine,
an intervening layer based on an oxide of silicon, and
a fourth layer based on titanium dioxide, wherein the fourth layer is photocatalytic.

More preferably the coated glazing comprises:
a transparent glass substrate, and
a coating located on the glass substrate,
wherein the coating comprises at least the following layers in sequence starting from the glass substrate:
a lower layer based on silicon dioxide, wherein the lower layer has a thickness of at least 5 nm, but at most 30 nm;
a first layer having a refractive index of more than 1.6, wherein the first layer is based on tin dioxide, wherein the first layer has a thickness of at least 5 nm, but at most 35 nm;
a second layer having a refractive index that is less than the refractive index of the first layer, wherein the second layer is based on silicon dioxide, wherein the second layer has a thickness of at least 15 nm, but at most 50 nm;
a third layer based on tin dioxide doped with fluorine, wherein the third layer has a thickness of at least 100 nm, but at most 300 nm;
an intervening layer based on silicon dioxide, wherein the intervening layer has a thickness of at least 5 nm, but at most 40 nm; and
a fourth layer based on titanium dioxide, wherein the fourth layer is photocatalytic and wherein the fourth layer has a thickness of at least 5 nm, but at most 35 nm.

For the immediately preceding two paragraphs, preferably the coating consists of the lower layer, the first layer, the second layer, the third layer, the intervening layer and the fourth layer.

Preferably the coating is located on a first major surface of the glass substrate. Preferably the coating coats the majority of the first major surface. More preferably the coating coats substantially all of the first major surface. Most preferably the coating coats all of the first major surface. Preferably at least one, more preferably each, of the lower layer, the first layer, the second layer, the third layer, the intervening layer and the fourth layer is a continuous layer. Preferably the lower layer directly coats all of the first major surface, i.e. the lower layer is in direct contact with all of the first major surface. Preferably at least one, more preferably each, of the first layer, the second layer, the third layer, the intervening layer and the fourth layer indirectly coats all of the first major surface. In this context, where a layer is said to “indirectly coat all of the first major surface” this means that if the layer in question was in direct contact with the first major surface rather than there being at least one other layer in between, then the layer in question would be in direct contact with all of the first major surface.

Preferably the coating has a specific photocatalytic activity in accordance with ISO/DIS 10678:2010 of greater than 0.4 nmol/cm² h, more preferably greater than 0.5 nmol/cm² h, even more preferably greater than 0.6 nmol/cm² h, even more preferably greater than 0.7 nmol/cm² h, most preferably greater than 0.8 nmol/cm² h.

Preferably the coating has a photocatalytic activity in accordance with EN 1096-5:2011 represented by a mean global change of haze of up to 3%, more preferably up to 2%, even more preferably up to 1.5%, most preferably up to 1%.

The transparent glass substrate may be clear or tinted. Preferably the transparent glass substrate is a clear transparent glass substrate. The transparent glass substrate may be a metal oxide-based glass pane. The glass pane may be a clear or tinted float glass pane. Preferably the glass pane is a clear glass pane. A typical soda-lime-silicate glass composition is (by weight), SiO₂ 69-74%; Al₂O₃ 0-3%; Na₂O 10-16%; K₂O 0-5%; MgO 0-6%; CaO 5-14%; SO₃ 0-2% and Fe₂O₃ 0.005-2%. The glass composition may also contain other additives, for example, refining aids, which would normally be present in an amount of up to 2%. By clear float glass, it is meant a glass having a composition as defined in BS EN 572-1 and BS EN 572-2 (2004). For clear float glass, the Fe₂O₃ level by weight is typically 0.11%. Float glass with an Fe₂O₃ content less than about 0.05% by weight is typically referred to as low iron float glass. Such glass usually has the same basic composition of the other component oxides i.e. low iron float glass is also a soda-lime-silicate glass, as is clear float glass. Typically tinted float glass has at least 0.5% by weight Fe₂O₃, e.g. 1.0% by weight Fe₂O₃.

Alternatively the glass pane is a borosilicate-based glass pane, an alkali-aluminosilicate-based glass pane, or an aluminium oxide-based crystal glass pane.

All transmittance, reflectance and colour (a* and b*) values mentioned in this specification are according to the CIELAB colour scale system using Illuminant D65, ten degree observer.

Preferably the coated glazing exhibits a visible light transmittance of at least 60%, more preferably at least 70%, even more preferably at least 80%, but preferably at most 95%, more preferably at most 90%, even more preferably at most 85%.

Preferably the coated glazing exhibits a maximum visible light film side reflectance of 30%, more preferably a maximum visible light film side reflectance of 25%, even more preferably a maximum visible light film side reflectance of 20%, most preferably a maximum visible light film side reflectance of 16%, but preferably a minimum visible light glass side reflectance of 2%, more preferably a minimum visible light glass side reflectance of 5%, more preferably a minimum visible light glass side reflectance of 10%, most preferably a minimum visible light glass side reflectance of 14%.

Preferably the coated glazing exhibits a maximum visible light glass side reflectance of 30%, more preferably a maximum visible light glass side reflectance of 25%, even more preferably a maximum visible light glass side reflectance of 20%, most preferably a maximum visible light glass side reflectance of 16%, but preferably a minimum visible light glass side reflectance of 2%, more preferably a minimum visible light glass side reflectance of 5%, more preferably a minimum visible light glass side reflectance of 10%, most preferably a minimum visible light glass side reflectance of 14%.

Preferably the coated glazing exhibits an a* coordinate in reflection on the film side of at least −10, more preferably at least −4, even more preferably at least −2, but preferably at most 5, more preferably at most 2, even more preferably at most 1.

Preferably the coated glazing exhibits a b* coordinate in reflection on the film side of at least −1, more preferably at least 2, even more preferably at least 3, but preferably at most 10, more preferably at most 6, even more preferably at most 5.

Preferably the coated glazing exhibits an a* coordinate in reflection on the glass side of at least −8, more preferably at least −4, even more preferably at least −3, but preferably at most 6, more preferably at most 2, even more preferably at most 1.

Preferably the coated glazing exhibits a b* coordinate in reflection on the glass side of at least −1, more preferably at least 3, even more preferably at least 4, but preferably at most 11, more preferably at most 7, even more preferably at most 6.

Preferably the coated glazing exhibits an a* coordinate in transmission of at least −7, more preferably at least −3, even more preferably at least −2, but preferably at most 5, more preferably at most 1, even more preferably at most 0.

Preferably the coated glazing exhibits a b* coordinate in transmission of at least −6, more preferably at least −2, even more preferably at least −1, but preferably at most 5, more preferably at most 1, even more preferably at most 0.

Preferably, the coating has a static water contact angle of at most 40°, more preferably at most 30°, even more preferably at most 25°, most preferably at most 20° after irradiation of the glazing using a UV lamp of peak wavelength 351 nm at an intensity of 32 W/m² for 2 hours. Freshly prepared or cleaned glass has a hydrophilic surface (a static water contact angle of lower than about 40° indicates a hydrophilic surface), but organic contaminants rapidly adhere to the surface increasing the contact angle. A particular benefit of coated glazings of the present invention is that even if the coating is soiled, irradiation by UV light of the right wavelength will reduce the contact angle by reducing or destroying those contaminants. A further advantage is that water will spread out over the low contact angle surface reducing the distracting effect of droplets of water on the surface (e.g. from rain) and tending to wash away any grime or other contaminants that have not been destroyed by the photocatalytic activity of the surface. The static water contact angle is the angle subtended by the meniscus of a water droplet on a glass surface and may be determined in a known manner by measuring the diameter of a water droplet of known volume (e.g. volume in the range 1 to 5 μl) on a glass surface after irradiation of the glazing using a UV lamp (peak wavelength 351 nm) at an intensity of 0.73 W/m² at 45° C. for 30 min.

Particular microbes which may be denatured by the coated glazing according to the present invention include for example but are not limited to: gram positive and gram negative bacteria, including for example Staphylococcus aureus and methicillin-resistant Staphylococcus aureus (MRSA), and corona viruses including SARS-CoV-2.

The coated glazing according to the present invention may reduce the survival of one or more microbes on the coated surface of the substrate, such as for example bacteria and/or viruses, compared to an uncoated substrate that is otherwise the same as the coated substrate. Preferably, growth of bacteria on the coated surface of the substrate is reduced by at least 10%, more preferably 20%, even more preferably 30%, compared to an uncoated substrate that is otherwise the same as the coated substrate. Preferably, deactivation of viruses on the coated surface of the substrate is increased by at least 10%, more preferably 20%, even more preferably 30%, compared to an uncoated substrate that is otherwise the same as the coated substrate.

Particular microbes which may be denatured by the coated glazing according to the present invention include for example but are not limited to: gram positive and gram negative bacteria, including for example Staphylococcus aureus and methicillin-resistant Staphylococcus aureus (MRSA), and corona viruses including SARS-CoV-2. Preferably the coated glazing according to the present invention provides a reduction 10% against one of Staphylococcus aureus, SARS-CoV-2, E. coli, P. gingivitis, or S. mutans, within 2 hours at 37° C. More preferably, the coated glazing according to the present invention provides a reduction of at least 20% against one of Staphylococcus aureus, SARS-CoV-2, E. coli, P. gingivitis, or S. mutans, more preferably at least 30%, and most preferably at least 40%, within 2 hours at 37° C.

In some preferred embodiments, for example where the reduction of external condensation is desired, in use, the first major surface of the glass substrate on which the coating is located faces away from a building in which it has been installed, i.e. the first major surface of the glass substrate faces the external environment and would commonly be named surface #1.

In other preferred embodiments, particularly where antimicrobial properties are preferred, in use, the first major surface of the glass substrate on which the coating is located faces towards a building in which it has been installed, i.e. the first major surface of the glass substrate faces the internal environment and would commonly be named surface #2 in a monolithic glazing or surface #4 in a double glazing.

In certain embodiments the coated glazing may further comprise a second coating located on an opposing major surface of the glass substrate, i.e. the coating referred to in the preceding paragraphs is located on a first major surface of the glass substrate and the second coating is located on the opposing major surface of the glass substrate. The second coating may comprise an antireflection, low-emissivity and/or solar control coating.

In some embodiments an opposing major surface of the glass substrate may be bonded to a second glass substrate by a ply of plastics interlayer. Preferably the plastics interlayer comprises polyvinyl butyral (PVB). In certain embodiments where antimicrobial properties are desired, the plastics interlayer does not comprise any UV-absorbers. In these embodiments, preferably the plastics interlayer is at least 70%, more preferably at least 80%, more preferably at least 90%, more preferably substantially, most preferably completely transparent to UV radiation. Any of the opposing major surface of the glass substrate and either surface of the second glass substrate may be coated, for example with an antireflection, low-emissivity and/or solar control coating.

In particular embodiments the coated glazing of the first aspect, e.g. the coated glazing of the two immediately preceding paragraphs, may be combined with further glass substrates (e.g. one or two further glass substrates) to form a glazing unit. The coated glazing may be held in a spaced apart relationship with any adjacent further glass substrate to form an insulated glazing unit. Any further glass substrate may be held in a spaced apart relationship with any adjacent further glass substrate to form an insulated glazing unit.

According to a second aspect of the present invention there is provided the use of the coated glazing of the first aspect to provide anticondensation, self-cleaning and/or antimicrobial properties. Preferably said use occurs in architectural or automotive applications. Said use may occur in a glazing frame, wall, bulkhead, blind, door, electronic device, touchscreen, mirror, container, furniture, splashback and/or vehicle window.

Preferably the use according to the second aspect of the present invention further comprises the step of irradiating the coated glazing with UV light from an artificial UV light source and/or from daylight. Preferably, the coated substrate is irradiated with UV light for at least 1 min, more preferably at least 20 min, even more preferably at least 1 hr, most preferably at least 2 hr. In relation to the present invention, UV light is electromagnetic radiation with a wavelength from 10 nm to 400 nm.

Preferably, the UV light has a peak wavelength above 200 nm, more preferably above 220 nm, even more preferably above 250 nm. In relation to the present invention, the peak wavelength of light is the wavelength with the highest intensity in the light spectrum. For example, the peak wavelength of UV light is the wavelength with the highest intensity in the UV spectrum of 10 to 400 nm.

Preferably, the UV light is activated using an automated sensor process or a timer. According to the present invention, an automated sensor process may include a sensor device for sensing parameter information and a communication system for relaying the parameter information to a computational device which determines a response.

Preferably, the UV light source is a mobile UV light source. Preferably the mobile UV light source may be actuated between a position where light from the UV light source may impinge upon the coated glazing, and a position in which light from the UV light source does not impinge upon the coated glazing. Preferably, the mobile UV light source is attached to a robotic device. Preferably the robotic device is: an actuating arm; a wheeled, legged or tracked mobile carrier; or a retracting arm.

Preferably, the use of the coated glazing according to the present invention further comprises a cleaning step, preferably wherein the coated glazing is cleaned with a cleaning product, preferably a detergent and/or a germicidal cleaning product. Preferably the cleaning step is an automated cleaning step, wherein the coated glazing is cleaned using sprayers, air knives and/or wipers. Alternatively, the cleaning step may be a manual cleaning step.

Any feature set out above in relation to the first aspect of the present invention may also be utilised in relation to any other aspects of the present invention.

Any invention described herein may be combined with any feature of any other invention described herein mutatis mutandis.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention will now be further described by way of the following specific embodiments, which are given by way of illustration and not of limitation, with reference to the accompanying drawing in which:

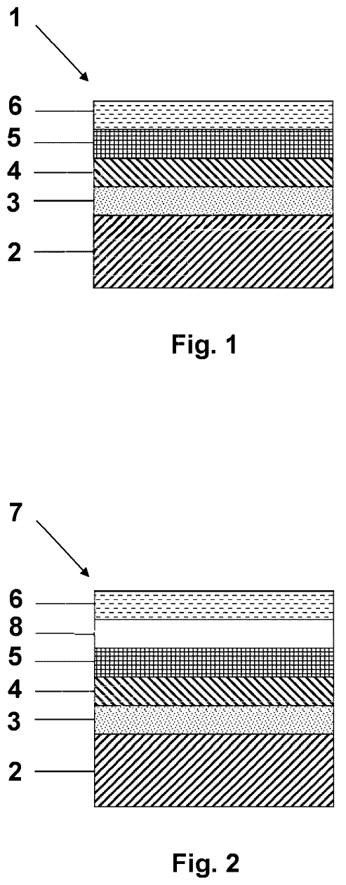

FIG. 1 is a schematic view, in cross-section, of a coated glazing with a four-layer coating in accordance with certain embodiments of the present invention,

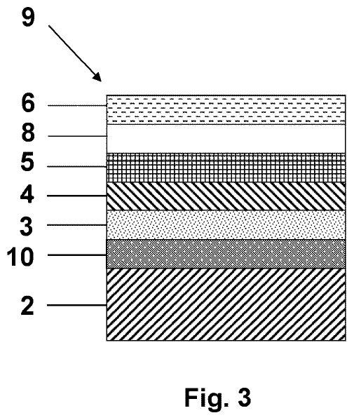

FIG. 2 is a schematic view, in cross-section, of a coated glazing with a five-layer coating in accordance with certain embodiments of the present invention, and

FIG. 3 is a schematic view, in cross-section, of a coated glazing with a six-layer coating in accordance with certain embodiments of the present invention.

FIG. 1 shows a cross-section of a coated glazing 1 according to certain embodiments of the present invention. Coated glazing 1 comprises a transparent float glass substrate 2 that has been sequentially coated using CVD with a first layer based on tin dioxide 3, a second layer based on silicon dioxide 4, a third layer based on fluorine doped tin oxide 5 and a fourth layer based on titanium dioxide 6. The CVD may be carried out in conjunction with the manufacture of the glass substrate in the float glass process.

FIG. 2 similarly shows a coated glazing 7 identical to the coated glazing 1 depicted in FIG. 1 except that an intervening layer based on silicon dioxide 8 is located between the third layer based on fluorine doped tin oxide 5 and the fourth layer based on titanium dioxide 6.

FIG. 3 shows a coated glazing 9 identical to the coated glazing 7 depicted in FIG. 2 except that a lower layer based on silicon dioxide 10 is located between the transparent float glass substrate 2 and the first layer based on tin dioxide 3.

### EXAMPLES

Examples 1-6 according to the invention were prepared using atmospheric pressure CVD as part of the float glass process. The transparent glass substrate used for each Example was clear soda-lime-silica glass with a thickness of 4 mm. Comparative Example 7 was commercially available Pilkington Anti-Condensation Glass, of 4 mm thickness. Comparative Example 8 was commercially available Pilkington Activ™, of 4 mm thickness.

The SnO₂ layers were deposited over the glass surface using the following components:
N₂ carrier gas, O₂, dimethyltin dichloride, and H₂O.

The SiO₂ layers were deposited over the glass surface using the following components:
N₂ carrier gas, He carrier gas, O₂, C₂H₄, and SiH₄.

The SnO₂:Sb layers were deposited over the glass surface using the following components:

N₂ and He carrier gas, O₂, dimethyltin dichloride, 30-50 wt % triphenyl antimony in ethyl acetate, and H₂O.

The TiO₂ layers were deposited over the glass surface using the following components:
Titanium tetrachloride in ethyl acetate (ratio EtOAc:TiCl₄ 1.8-2.2) for Comparative Example 8.
Titanium tetraisopropoxide and O₂ for Examples 1-6.

The SnO₂:F layers were deposited over the glass surface using the following components:
N₂ carrier gas, O₂, dimethyltin dichloride, HF, and H₂O.

The thicknesses of the individual layers of the samples were as follows:

Examples 1-6: Glass/SiO₂ (20 nm)/SnO₂ (25 nm)/SiO₂ (25 nm)/SnO₂:F (230 nm)/TiO₂ (Examples 1-2, ≥1 nm, <5 nm; Examples 3-4, 5 nm, <10 nm; Example 5, 15 nm, Example 6, 18 nm)

Comparative Example 7: Glass/SiO₂ (20 nm)/SnO₂ (25 nm)/SiO₂ (25 nm)/SnO₂:F (230 nm)

Comparative Example 8: SiO₂ (35 nm)/TiO₂ (17 nm).

The optical properties shown below in Table 1 were determined using a HunterLab™ Ultrascan Pro spectrophotometer. The layer thicknesses of the Examples were determined by scanning electron microscopy (SEM) using an FEI Nova NanoSEM™ 450 and EDAX Octane plus EDS detector with TEAM software.

TABLE 1
Optical properties of Examples 1-6 according
to the invention and Comparative Example 7

| | Coated Reflection (%) | | | Glass Reflection (%) | | | Transmission (%) | | |
|---|---|---|---|---|---|---|---|---|---|
| Sample | a* | b* | Y | a* | b* | Y | a* | b* | Y |
| Example 1 | −1.81 | 4.62 | 14.7 | −2.08 | 4.8 | 14.22 | −0.32 | −0.75 | 81.7 |
| Example 2 | 0.26 | 4.59 | 14.75 | −0.03 | 4.84 | 14.4 | −0.99 | −0.75 | 81.7 |
| Example 3 | −0.03 | 4.37 | 15.17 | −0.36 | 4.91 | 14.75 | −0.97 | −0.72 | 81.36 |
| Example 4 | −1.36 | 4.91 | 15.24 | −1.45 | 5.39 | 14.96 | −0.48 | −0.79 | 80.92 |
| Example 5 | 0.875 | 3.54 | 15.72 | 0.38 | 4.35 | 15.19 | −1.21 | −0.35 | 80.45 |
| Example 6 | 0.445 | 3.88 | 15.90 | 0.03 | 4.54 | 15.6 | −1.28 | −0.28 | 80.14 |
| Comparative | −2.25 | −0.6 | 13.64 | −2.35 | −0.22 | 13.3 | −0.23 | 0.66 | 82.79 |
| Example 7 | | | | | | | | | |

The static water contact angle of these samples was determined by measuring the diameter of a water droplet (5 μl) on the glass surface after irradiation of the glazing using a UV lamp (peak wavelength 351 nm) at an intensity of 0.73 W/m2 at 45° C. for 30 min (shown in the column labelled “UV” in Table 2 below). The static water contact angle of these samples was also determined immediately after storing the samples in the dark for 72 hrs (shown in the column labelled “Dark” in Table 2 below).

TABLE 2
Comparison of static water contact angles for Examples
1-6 according to the invention and Comparative Examples
7 and 8 in the dark and after UV irradiation
Static Water Contact Angle Comparison

| Sample | Dark | UV |
|---|---|---|
| Example 1 | 80° | 17° |
| Example 2 | 83° | 16° |
| Example 3 | 73° | 22° |
| Example 4 | 78° | 24° |
| Example 5 | 77° | 15° |
| Example 6 | 74° | 16° |
| Comparative Example 7 | 61° | 60° |
| Comparative Example 8 | 79° | 10° |

The static water contact angle may be attributed to the photoactivity of the coated surface, which is capable of destroying organic dirt on the surface which would otherwise increase the contact angle of the surface above 30° and act as a potential nucleation area for external condensation. The above results demonstrate that the coated glazings according to the present invention exhibit very low static water contact angles upon irradiation with UV light.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1.-23. (canceled)

24. A coated glazing comprising:
a transparent glass substrate, and
a coating located on the glass substrate,
wherein the coating comprises at least the following layers in sequence starting from the glass substrate:
a first layer having a refractive index of more than 1.6,
an optional second layer having a refractive index that is less than the refractive index of the first layer,
a third layer based on tin dioxide doped with fluorine, and
a fourth layer based on titanium oxide, wherein the fourth layer is photocatalytic.

25. The coated glazing according to claim 24, wherein the glazing further comprises an intervening layer based on an oxide of silicon and located between the third and fourth layers.

26. The coated glazing according to claim 25, wherein the intervening layer is based on silicon dioxide.

27. The coated glazing according to claim 24, wherein the glazing further comprises a lower layer having a refractive index that is less than the refractive index of the first layer and wherein the lower layer is located between the glass substrate and the first layer.

28. The coated glazing according to claim 27, wherein the lower layer is based on an oxide of a metalloid, preferably based on an oxide of silicon or silicon oxynitride.

29. The coated glazing according to claim 27, wherein the lower layer has a thickness of at least 5 nm, but at most 30 nm.

30. The coated glazing according to claim 25, wherein when the intervening layer is present, the first layer has a thickness of at least 5 nm, but at most 35 nm.

31. The coated glazing according to claim 25, wherein when the intervening layer is present, preferably the second layer has a thickness of at least 15 nm, but at most 50 nm.

32. The coated glazing according to claim 25, wherein when the intervening layer is present, the third layer has a thickness of at least 100 nm, but at most 300 nm.

33. The coated glazing according to claim 25, wherein the intervening layer has a thickness of at least 5 nm, but at most 40 nm.

34. The coated glazing according to claim 25, wherein when the intervening layer is present, the fourth layer has a thickness of at least 5 nm, but at most nm.

35. The coated glazing according to claim 24, wherein the first layer is based on an oxide of a metal, preferably the first layer is based on tin dioxide, niobium oxide, titanium dioxide, SiCO or tantalum oxide.

36. The coated glazing according to claim 24, wherein the first layer is based on tin dioxide.

37. The coated glazing according to claim 24, wherein the second layer is present and based on an oxide of a metalloid, preferably the second layer is based on a silicon oxide or silicon oxynitride.

38. The coated glazing according to claim 25, wherein the coated glazing comprises:
a transparent glass substrate, and
a coating located on the glass substrate,
wherein the coating comprises at least the following layers in sequence starting from the glass substrate:
a first layer having a refractive index of more than 1.6, wherein the first layer is based on tin dioxide, wherein the first layer has a thickness of at least 5 nm, but at most nm;
a second layer having a refractive index that is less than the refractive index of the first layer, wherein the second layer is based on silicon dioxide, wherein the second layer has a thickness of at least 15 nm, but at most 50 nm;
a third layer based on tin dioxide doped with fluorine, wherein the third layer has a thickness of at least 100 nm, but at most 300 nm;
an intervening layer based on silicon dioxide, wherein the intervening layer has a thickness of at least 5 nm, but at most 40 nm; and
a fourth layer based on titanium dioxide, wherein the fourth layer is photocatalytic and wherein the fourth layer has a thickness of at least 5 nm, but at most 35 nm.

39. The coated glazing according to claim 25, wherein the coated glazing comprises:
a transparent glass substrate, and
a coating located on the glass substrate,
wherein the coating comprises at least the following layers in sequence starting from the glass substrate:
a lower layer based on an oxide of silicon,
a first layer having a refractive index of more than 1.6, wherein the first layer is based on tin dioxide,
a second layer having a refractive index that is less than the refractive index of the first layer, wherein the second layer is based on an oxide of silicon,
a third layer based on tin dioxide doped with fluorine,
an intervening layer based on an oxide of silicon, and
a fourth layer based on titanium dioxide, wherein the fourth layer is photocatalytic.

40. The coated glazing according to claim 25, wherein the coated glazing comprises:
a transparent glass substrate, and
a coating located on the glass substrate,
wherein the coating comprises at least the following layers in sequence starting from the glass substrate:
a lower layer based on silicon dioxide, wherein the lower layer has a thickness of at least 5 nm, but at most 30 nm;
a first layer having a refractive index of more than 1.6, wherein the first layer is based on tin dioxide, wherein the first layer has a thickness of at least 5 nm, but at most nm;
a second layer having a refractive index that is less than the refractive index of the first layer, wherein the second layer is based on silicon dioxide, wherein the second layer has a thickness of at least 15 nm, but at most 50 nm;
a third layer based on tin dioxide doped with fluorine, wherein the third layer has a thickness of at least 100 nm, but at most 300 nm;
an intervening layer based on silicon dioxide, wherein the intervening layer has a thickness of at least 5 nm, but at most 40 nm; and
a fourth layer based on titanium dioxide, wherein the fourth layer is photocatalytic and wherein the fourth layer has a thickness of at least 5 nm, but at most 35 nm.

41. The coated glazing according to claim 24, wherein the coating has a static water contact angle of at most 40°, more preferably at most 30°, even more preferably at most 25°, most preferably at most 20° after irradiation of the glazing using a UV lamp of peak wavelength 351 nm at an intensity of 0.73 W/m2 at 45° C. for 30 min.

42. The coated glazing according to claim 24, wherein the coated glazing reduces the survival of one or more microbes on the coated surface of the substrate, such as for example bacteria and/or viruses, compared to an uncoated substrate that is otherwise the same as the coated substrate.

43. A method of providing a coating glazing with anticondensation, self-cleaning and/or antimicrobial properties, comprising irradiating the coated glazing according to claim 24 with UV light from an artificial UV light source and/or from daylight for at least 1 min, preferably wherein the UV light has a peak wavelength above 200 nm, more preferably above 220 nm, even more preferably above 250 nm.
